(19) United States
(12) Patent Application Publication
(10) Pub. No.: US 2009/0228903 A1
(43) Pub. Date: Sep. 10, 2009

(54) DATA EVENT SENDING METHOD AND APPARATUS AND EVENT PROCESSING SYSTEM

(75) Inventors: Yi Che, Beijing (CN); Yan Zhou, Beijing (CN); Cheng Zhang, Beijing (CN)

Correspondence Address: Novak Druce + Quigg LLP, CityPlace Tower, 525 Okeechobee Blvd., Fifteenth-Floor, WEST PALM BEACH, FL, 33401, US

(73) Assignee: INTERNATIONAL BUSINESS MACHINES CORPORATION, Armonk, NY (US)

(21) Appl. No.: 12/395,259

(22) Filed: Feb. 27, 2009

(30) Foreign Application Priority Data
Feb. 29, 2008 (CN) 200810080935.X

(51) Int. Cl. G06F 9/46

(52) U.S. Cl. 719/318; 707/104.1; 719/313

(57) ABSTRACT

The present invention is directed to an apparatus, system, methods, and computer-program product for sending a data event so that a work flow event can be correlated with a data event. According to one embodiment of the invention, a data event sending apparatus can be provided. The apparatus can include a receiver for receiving data revised by a node from which a work flow event is emitted, a formatter for obtaining correlation information on the work flow event according to predefined logic for the revised data, and for formatting the revised data and the correlation information to obtain a data event, and a sender for sending the data event.

### CROSS-REFERENCE TO RELATED APPLICATION

This application claims the benefit of Chinese Patent Application No. 200810080935.X filed on Feb. 29, 2008, which is hereby incorporated by reference.

### FIELD OF THE INVENTION

The present invention generally relates to the field of event processing and, more specifically to processing data events correlated with work flow events.

### BACKGROUND OF THE INVENTION

Business monitoring is an important part of a business process lifecycle, which makes the business process real-time visible and which can provide timely information on the business process. In general, business monitoring comprises analyzing events sent from the execution of a business process, extracting the concerned information and analyzing and processing them for later data mining.

In a business process, a node can emit work flow events to identify the execution status of the business process and states of nodes while processing businesses. Additionally, nodes can control data in the business process.

Some applications have been employed for monitoring work flow events so as to enable clients to keep informed of the progress and state of a business process. If events and data in the whole work flow are implemented by one software system, then complete states of events and data in the work flow can be obtained by checking work flow events. However, the control of a work flow is separated from the operation of data in some applications.

For example, in an application of applying for credit cards controlled by banks, the applying process is controlled by a work flow engine, while the operation of a database is implemented by an existing application of database operation upon request of the work flow engine. Thus, work flow event monitoring software can only obtain work flow events emitted from the work flow engine, but not the data operation these events involve. Similarly, the client can obtain records on data revision through database logs. However, the client is only aware of the revised data but lacks the knowledge of work flow events that request related data. Thus, since work flow events lack the control of data operation or the control of data operation lacks the context of work flow events, the client cannot correlate work flow events with data events, which is not advantageous to later event processing. Therefore, the client hopes to simultaneously monitor work flow events and data events in a business process and correlate work flow events with data events.

Additionally, the client to simultaneously monitor work flow events and data events in a business process without changing the operation of existing data.

Therefore, there is currently a problem of how to correlate work flow events and data events in a business process without affecting the existing architecture, in order to better monitor or control the business process.

### SUMMARY OF THE INVENTION

The present invention is directed to an apparatus, system, methods, and computer-program product for sending a data event so that a work flow event can be correlated with a data event. According to one embodiment of the invention, a data event sending apparatus can be provided. The apparatus can include a receiver for receiving data revised by a node from which a work flow event is emitted, a formatter for obtaining correlation information on the work flow event according to predefined logic for the revised data, and for formatting the revised data and the correlation information to obtain a data event, and a sender for sending the data event.

According to another embodiment of the invention, an event processing system can be provided. The system can include a data storage for storing data, a node for emitting work flow event and revising data in the data storage, a data event sending apparatus including a receiver for receiving data revised by the node from which a work flow event is emitted, a formatter for obtaining correlation information on the work flow event according to predefined logic for the revised data and for formatting the revised data and the correlation information to obtain a data event, and a sender for sending the data event. Furthermore, the system can include an event processor for correlating the data event with the work flow event.

In yet another embodiment of the invention, a data event sending method can be provided. The method can include receiving data revised by a node from which a work flow event is emitted, obtaining correlation information on the work flow event according to predefined logic for the revised data, formatting the revised data and the correlation information to obtain a data event, and sending the data event. In still another embodiment, a computer-program product for data event sending is provided.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a block diagram of an event processing system according to an embodiment of the present invention;

FIG. 2 is a flowchart of a data event sending method according to another embodiment of the present invention;

FIG. 3 is a block diagram of a data event sending apparatus according to another embodiment of the present invention; and

FIG. 4 is a block diagram showing the structure of a computer system suitable to implement the present invention.

### DETAILED DESCRIPTION

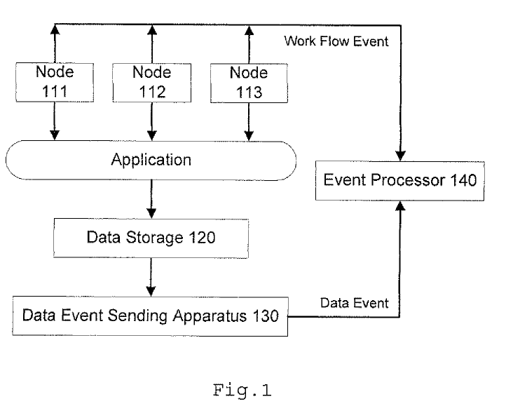

Embodiments of the present invention provide an apparatus, system, method, and computer-program product for sending a data event so that a work flow event can be correlated with a data event. Among terms used in the present application, a business process is a set of correlated activities in which one or more nodes transform inputs into more valuable outputs; a work flow event is a message emitted by nodes to identify the execution status of a business process and states of nodes; a data event is a message generated by nodes revising the data in a data storage, which can comprise: a base portion containing the revised data, and an extended portion containing the correlation information between the revised data and work flow events, so as to make data events correlated with work flow events. In further illustration, FIG. 1 is a block diagram of an event processing system according to an embodiment of the present invention. The system includes a data event sending apparatus 130 coupled to a data storage 120, and event processor 140. The system also includes nodes 111-113 of an application coupled to the data storage 120. It should be noted although only three nodes are shown in this embodiment, the present invention is not limited to this and more nodes can apply to the present invention.

Data storage 120 can be configured for storing data, which may be a database comprising a plurality of tables each comprising a plurality of entries each comprising a plurality of fields. Data storage 120 may also be a data file that can store data in the form of binary code or ASCII code. Nodes 111-113 can directly revise data in the data storage 120, such as add, delete or update data in the database or data file, or can indirectly revise data by requesting an application of database operation as shown in FIG. 1. Additionally, nodes 111-113 can emit work flow events in a business process to indicate the execution status of the business process and states of nodes. Data event sending apparatus 130 can be configured to carry out the following functions. First, the data event sending apparatus 130 can be configured to receive from the data storage 120 data revised by a node that emits a work flow event.

For example, upon receipt of a message by nodes 111-113 indicating a new revision of data in the database, the data event sending apparatus 130 can read the revised data from data storage 120. In another example, data event sending apparatus 130 periodically can receive revised data responsive to detecting revised data in the data file of data storage 120. Next, data event sending apparatus 130 can obtain correlation information on work flow events according to predefined logic for revised data, which predefined logic defines which kind of correlation information is set for which kind of data. The correlation information includes information on work flow events, such as node identifier, instance identifier, sequence identifier, and time stamp. Then, data event sending apparatus 130 can format the revised data together with the correlation information on work flow events to obtain a data event. Finally, data event sending apparatus 130 can send the data event.

Event processor 140 can be configured for correlating data events from data event sending apparatus 130 with work flow events from nodes 111-113, so that users can perform monitoring, controlling, or the like on correlated work flow events and data events during the business process.

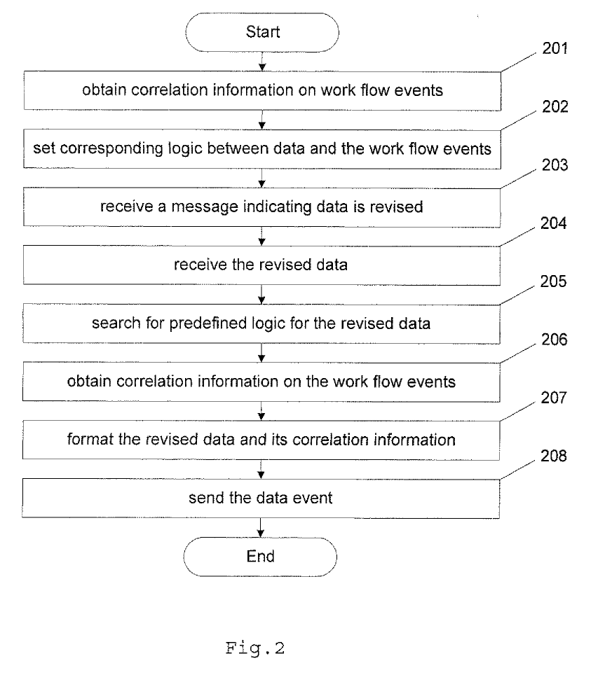

In further illustration, FIG. 2 is a flowchart of a data event sending method according to another embodiment of the present invention. In this embodiment a credit card applying process is taken as an example of the business process. Nodes in the credit card applying process can be, for example, an application receiver node, an examination & approval node, a rechecking node and other nodes. The data event sending method of the present invention is described in the context of an application receiver node in this embodiment. With the method of the present invention, users can simultaneously monitor or control work flow events emitted from the application receiver node and data events correlated with the work flow events.

In the credit card applying process, for example, all actions of applying for a credit card are emitted to the application receiver node (ApplicationReceiver), so the node identifier (NodeID) can be used for identifying events related to the node. If work flow events and data events have the same node identifier “ApplicationReceiver”, i.e. are all related to the application receiver node, then they are monitored or controlled. At the same time, the monitoring or control will not be affected by work flow events and data events that are related to other nodes. In this manner, the relative independence of the monitoring or control is ensured.

In the credit card applying process, each credit card application instance is unique, so each instance identifier (instanceID) of the credit card application identifies a different credit card application instance. The instance identifier of the credit card application can be set using permutations of letters and numerals and serial numbers.

For example, the InstanceID can be 1182261010219. If work flow events and data events have the same InstanceID “1182261010219,” i.e. are related with the same credit card application instance, then they can be monitored or controlled. At the same time, the monitoring or control will not be affected by work flow events and data events that are related to other nodes. In this manner, the relative independence of the monitoring or control is ensured.

The application receiver Node can add data to the data storage by invoking an application, and the time when the data is added to the data storage can be used as a time stamp for correlating respective event with a time sequence. If the respective time stamps of work flow events and data events are known, then the precedence of these events is also known so as to facilitate the monitoring or control of these events. Additionally, those skilled in the art will recognize that other sequence identifiers other than the time stamp can be used to identify time sequences.

Beginning in step 201, correlation information on work flow events can be obtained. The correlation information may be, for example, node identifier, instance identifier, sequence identifier (such as time stamp) and the like.

In step 202, corresponding logic between data and work flow events can be set using the correlation information obtained in step 201. The data storage can preferably be a database that comprises a plurality of tables such as an applicant information table, a credit card information table and the like. Notably, the data storage can be one or more databases. Predefined logic can be set for each of a plurality of databases, or further, predefined logic can be set for each table in each database. The data storage can also be one or more data files, and predefined logic can be set for each of a plurality of data files.

As an example, the applicant information table can include fields of applicant name, age, e-mail and so on. The corresponding logic between the applicant information table and a work flow event can be set as follows: add to the applicant information table the application receiver node identifier “ApplicationReceiver,” the credit card application instance identifier “1182261010219” and the time stamp “2007-06-19 13:50:16”. In this manner, data in the applicant information table can be correlated with the node whose identifier is “ApplicationReceiver,” the instance whose identifier is “1182261010219” and the work flow event which is emitted at 13:50:16 on Jun. 19, 2007.

For example, the revision of data in the applicant information table can be requested by the node whose identifier is “ApplicationReceiver”, implemented in the instance whose identifier is “1182261010219”, and closely correlated with the work flow event which is emitted at 13:50:16 on Jun. 19, 2007.

The credit card information table can include fields of credit card name, currency type, line which an applicant may specify. Corresponding logic between the credit card information table and work flow events can be set, for example, as follows: add to the credit card information table the application receiver node identifier “ApplicationReceiver” and the credit card application instance identifier “1182261010001.” In this manner, data in the credit card information table can be correlated with the work flow event which has the instance identifier “1182261010001” and which is emitted from the node having the node identifier “ApplicationReceiver”.

For example, the revision of data in the credit card information table can be requested by the node whose identifier is “ApplicationReceiver”, and also can be implemented in the instance whose identifier is “1182261010001.”

In another example, if time is of less relevance to the credit card information table, a time stamp may not be added to the correlation information. However, those skilled in the art will recognize that the above settings of predefined logic are merely illustrative and not limiting.

In step 203, a message indicating revised data can be received. When the application receiver node revises data in the database, the database can send via an internal message delivery mechanism a message indicating data is revised.

For example, an update flag is added to a trigger of the database when data is being revised, to form update logs. Another possible approach is that a detector outside the database can periodically detect the change of the database and sends a message indicating data is revised when there is. The detector can be implemented inside the database or at other location in a proper manner.

The message indicating a new revision of data can include information regarding which database or data file the revised data comes from, and which table of the database the revised data comes from (if the revised data is stored in a data file, then the message can indicate which data file the revised data comes from).

The message indicating a new revision of data can include information regarding the source of data from the application receiver database and from the applicant information table in the application receiver database.

In step 204, the revised data is searched for and read from the applicant information table in the application receiver database based on the message indicating data is revised as received in step 203.

For example, the revised data can be a new entry inserted to the applicant information table, which comprises applicant name “Li Ming,” age “30,” e-mail “liming30@yahoo.com.cn” and other information. Description is given below to the new entry:

<applicationData>

<CustomerName>Li Ming</ CustomerName >
<CustomerAge>30</CustomerAge>
<CustomerMail> liming30@yahoo.com.cn </CustomerMail>
. . .

<applicationData>

In step 205, predefined logic set for the revised data can be searched based on identifying where the data originates from. Since corresponding logic between the applicant information table and work flow events can be set in step 202, predefined logic related to the applicant information table can be searched in order to obtain the correlation information on work flow events.

In step 206, the correlation information on work flow events can be obtained according to the predefined logic for the revised data as obtained in step 205.

If the predefined logic related to the applicant information table is found, then the correlation information on work flow events in the applicant information table can be obtained. The correlation information can include the application receiver node identifier “ApplicationReceiver”, the node identifier “1182261010219” and the time stamp “2007-06-19 13:50:16”. The obtained correlation information is as follows:

<EventHeaderData>

<NodeID>ApplicationReceiver</ApplicationID>
<InstanceID>1182261010219</InstanceID>
<TimeStamp>2007-06-19 13:50:16</TimeStamp>

</EventHeaderData>

In step 207, the revised data and its correlation information can be formatted to obtain a data event. First, a blank data event can be created. Then, the revised data received in step 204 can be used as base portion of the data event, and the correlation information correlated with work flow events as obtained in step 206 can be used as extended portion of the data event. The revised data and the correlation information related with work flow events can be respectively filled to proper locations of the data event so that formatting is completed and a complete data event can be obtained.

During the formatting procedure, as long as later processing can be aware of the format of a data event, the base portion and the extended portion of the data event can be disposed in any manner. Thus the data event can be formatted in any manner.

For example, the base information can be disposed at the header of the data event, and the extended portion can be disposed after the base portion, or vice versa. For another example, the extended portion can be divided into two or more parts which are respectively disposed at the header, tail or other location of the data event.

Further, in step 208, the obtained data event can be sent so that the data event can be correlated with work flow events. The data storage can be one or more data files, in which the stored data can be in the form of binary code or ASCII code. Therefore, when corresponding logic between data and work flow events is being set in step 202, predefined logic is set for each data file rather than for the database or each table in the database.

Additionally, when a message indicating data is revised is received in step 203, since the data file does not have an internal message delivery mechanism that sends a message indicating data is revised, a detector is employed to periodically detect the data file, in order to find whether data in the data file is revised or not. The detector can be implemented at any location capable of accessing the data file.

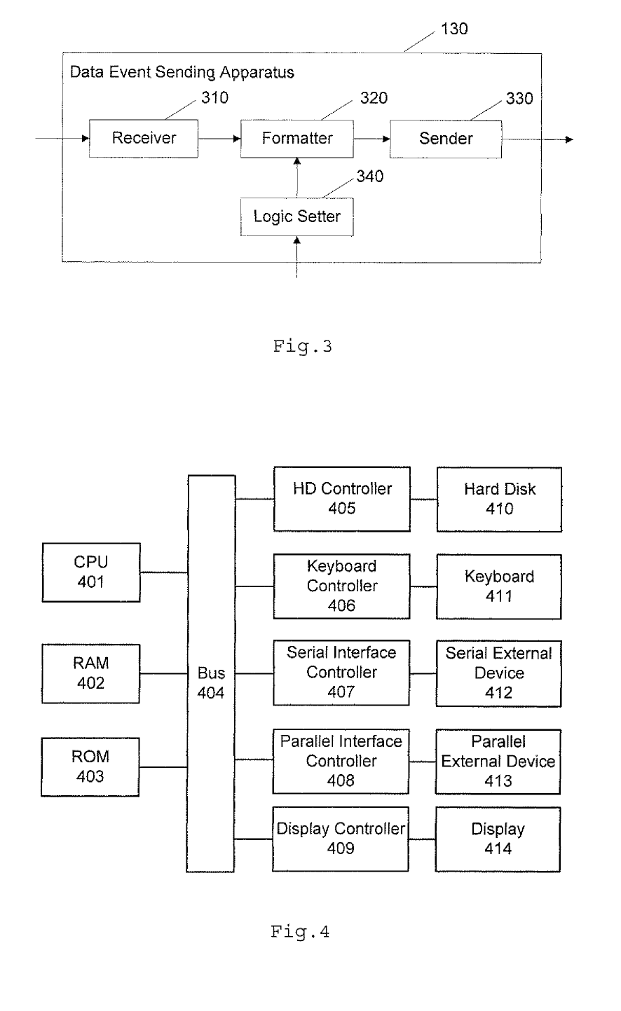

FIG. 3 is a block diagram of data event sending apparatus 130 according to another embodiment of the present invention. Data event sending apparatus 130 can include a receiver 310 coupled to a formatter 320. The formatter 320 can be coupled to a sender 330 and a logic setter 340.

Receiver 310 can be configured for receiving data revised by nodes. The receiver 310 can receive from the data storage a message indicating data is revised by nodes, and then receive the revised data according to the message. The receiver 310 can also periodically detect if data in the data storage is revised by nodes and receive the revised data when there is. The data storage can be a database and/or a data file.

Formatter 320 can be configured for obtaining correlation information on work flow events according to predefined logic for the revised data, and formatting the revised data as the base portion of a data event and the correlation information on work flow events as the extended portion of the data event, so that the data event is obtained. Sender 330 can be configured for sending the obtained data event.

Logic setter 340 is for obtaining correlation information on work flow event and setting corresponding logic between data and work flow events using the correlation information, thereby completing the setting of the predefined logic. The correlation information can comprise at least one of node identifier, instance identifier, sequence identifier and time stamp.

FIG. 4 schematically shows a block diagram of the structure of a computer device in which the embodiments according to the present invention may be implemented. The computer system shown in FIG. 4 can include a CPU (Central Processing Unit) 401, a RAM (Random Access Memory) 402, a ROM (Read Only Memory) 403, a system bus 404, a Hard Disk controller 405, a keyboard controller 406, a serial interface controller 407, a parallel interface controller 408, a display controller 409, a hard disk 410, a keyboard 411, a serial external device 412, a parallel external device 413 and a display 414. Among these components, connected to system bus 404 are CPU 401, RAM 402, ROM 403, hard disk controller 405, keyboard controller 406, serial interface controller 407, parallel interface controller 408 and display controller 409. Hard disk 410 is connected to HD controller 405, and keyboard 411 to keyboard controller 406, serial external device 412 to serial interface controller 407, parallel external device 413 to parallel interface controller 408, and display 414 to display controller 409.

The functions of each component in FIG. 4 are well known in the art, and the architecture shown in FIG. 4 is conventional. Such an architecture applies to not only personal computers but also hand held devices such as Palm PCs, PDAs (personal data assistants), mobile telephones, etc. In different applications, some components may be added to the architecture shown in FIG. 4, or some of the components shown in FIG. 4 may be omitted. The whole system shown in FIG. 4 is controlled by computer readable instructions, which are usually stored as software in hard disk 410, EPPROM or other non-volatile memory. The software can also be downloaded from the network (not shown in the figure). The software, either saved in hard disk 410 or downloaded from the network, can be loaded into RAM 402, and executed by CPU 401 for implementing the functions defined by the software.

As the computer system shown in FIG. 4 is able to support the solution according to the present invention, the computer system merely serves as an example of computer systems. Those skilled in the art may understand that many other computer system designs are also able to carry out the embodiments of the present invention.

The present invention may further be implemented as a computer program product used by, for example the computer system shown in FIG. 4, which may contain codes for implementing a data event sending method according to the present invention and codes for implementing a data event sending apparatus according to the present invention. The code may be stored in a memory of other computer system prior to the usage. For instance, the code may be stored in a hard disk or a removable memory like an optical disk or a floppy disk, or may be downloaded via the Internet or other computer network.

The disclosed method of the present invention may be implemented in software, hardware or a combination of software and hardware. The hardware part may be implemented using a dedicated logic, and the software part may be stored in a memory and be implemented by a proper instruction implementing system, such as a microprocessor, a personal computer (PC) or a mainframe.

The present invention further relates to a computer program product which contains codes for receiving data revised by a node from which a work flow event is emitted, obtaining correlation information on the work flow event according to predefined logic for the revised data, formatting the revised data and the correlation information to obtain a data event, and sending the data event. Such a computer program product may be stored in a storage carrier.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

We claim:

1. A data event sending method, comprising the steps of:
receiving data revised by a node from which a work flow event is emitted; obtaining correlation information on the work flow event according to predefined logic for the revised data;
formatting the revised data and the correlation information to obtain a data event; and sending the data event.

2. The method according to claim 1, wherein the step of receiving data revised by a node comprises:
receiving from data storage a message indicating data is revised by a node; and
reading the revised data according to the message.

3. The method according to claim 1, wherein the step of receiving data revised by a node comprises:
periodically detecting if data in data storage is revised by a node; and
reading the revised data when the data is detected to be revised.

4. The method according to claim 2 or 3, wherein the data storage is a database and/or a data file.

5. The method according to claim 1, further comprising presetting the predefined logic.

6. The method according to claim 5, wherein the step of presetting the predefined logic comprises:
obtaining correlation information on the work flow event; and
setting corresponding logic between data and the work flow event using the correlation information.

7. The method according to claim 6, wherein the correlation information comprises at least one of node identifier, instance identifier, sequence identifier and time stamp.

8. A data event sending apparatus, comprising:
a receiver configured for receiving data revised by a node from which a work flow event is emitted;
a formatter configured for obtaining correlation information on the work flow event according to predefined logic for the revised data, and for formatting the revised data and the correlation information to obtain a data event; and
a sender configured for sending the data event.

9. The apparatus according to claim 8, wherein the receiver is further configured for:
receiving from a data storage a message indicating data is revised by a node; and
reading the revised data according to the message.

10. The apparatus according to claim 8, wherein the receiver is further configured for:
periodically detecting if data in a data storage is revised by a node; and
reading the revised data when the data is detected to be revised.

11. The apparatus according to claim 9 or 10, wherein the data storage is a database and/or a data file.

12. The apparatus according to claim 8, further comprising a logic setter configured for presetting the predefined logic.

13. The apparatus according to claim 12, wherein the logic setter is further configured for:
obtaining correlation information on the work flow event; and
setting corresponding logic between data and the work flow event using the correlation information.

14. The apparatus according to claim 13, wherein the correlation information comprises at least one of node identifier, instance identifier, sequence identifier and time stamp.

15. An event processing system comprising:
a data storage for storing data;
a node for emitting a work flow event and revising data in the data storage;
a data event sending apparatus comprising:
a receiver for receiving data revised by the node from which a work flow event is emitted,
a formatter for obtaining correlation information on the work flow event according to predefined logic for the revised data and for formatting the revised data and the correlation information to obtain a data event, and
a sender for sending the data event; and
an event processor for correlating the data event with the work flow event.

16. The system according to claim 15, wherein the receiver is further configured for receiving from the data storage a message indicating data is revised by a node; and reading the revised data according to the message.

17. The system according to claim 15, wherein the receiver is further configured for periodically detecting if data in the data storage is revised by a node; and reading the revised data when the data is detected to be revised.

18. The system according to claim 16 or 17, wherein the data storage is a database and/or a data file.

19. The system according to claim 15, wherein the data event sending apparatus further comprises a logic setter for presetting the predefined logic.

20. The system according to claim 19, wherein the logic setter is further configured for:
obtaining correlation information on the work flow event; and
setting corresponding logic between data and the work flow event using the correlation information.

21. The system according to claim 20, wherein the correlation information comprises at least one of node identifier, instance identifier, sequence identifier and time stamp.

22. A computer-readable storage medium having stored therein computer-readable instructions, which, when loaded in and executed by a computer causes the computer to perform the steps of:
receiving data revised by a node from which a work flow event is emitted; obtaining correlation information on the work flow event according to predefined logic for the revised data;
formatting the revised data and the correlation information to obtain a data event; and sending the data event.

23. The computer-readable storage medium of claim 22, wherein the step of receiving data revised by a node comprises:
receiving from data storage a message indicating data is revised by a node; and
reading the revised data according to the message.

24. The computer-readable storage medium of claim 22, wherein the step of receiving data revised by a node comprises:
periodically detecting if data in data storage is revised by a node; and
reading the revised data when the data is detected to be revised.

25. The computer-readable storage medium of claim 23, wherein the data storage is a database and/or a data file.

26. The computer-readable storage medium of claim 22, further comprising presetting the predefined logic.

27. The computer-readable storage medium of claim 26, wherein the step of presetting the predefined logic comprises:
obtaining correlation information on the work flow event; and
setting corresponding logic between data and the work flow event using the correlation information.

28. The computer-readable storage medium of claim 27, wherein the correlation information comprises at least one of node identifier, instance identifier, sequence identifier and time stamp.
